(19) United States
(12) Patent Application Publication
(10) Pub. No.: US 2010/0201819 A1
(43) Pub. Date: Aug. 12, 2010

(54) DRIVE RECORDER, DRIVE RECORDER SYSTEM, METHOD OF CONTROLLING DRIVE RECORDER, AND PROGRAM

(75) Inventor: Masahiro Minowa, Nagano (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Seiko Epson Corporation, Shinjuku-ku (JP)

(21) Appl. No.: 12/671,457

(22) PCT Filed: Jul. 4, 2008
(86) PCT No.: PCT/JP2008/001787

§ 371 Date: Jan. 29, 2010

(30) Foreign Application Priority Data
Jul. 30, 2007 (JP) 2007-197028

(51) Int. Cl. H04N 7/18

(52) U.S. Cl. 348/148; 348/E07.085

(57) ABSTRACT

A drive recorder is provided that can reduce a risk of losing evidence data in the event of occurrence of an accident. The drive recorder includes an image capture unit that captures a front view of a vehicle in a traveling state, a movie image data generation unit that generates movie image data from a captured video signal, a storage section that stores movie image data, a recording unit that records movie image data into the storage section, an event occurrence detection unit that detects the occurrence of an accident, a still image data generation unit that generates still image data including a plurality of still images at predetermined intervals from the video signal, a first transmission unit that transmits still image data to an external device via a wireless network when the event occurrence detection unit detects the occurrence of an accident, and a second transmission unit that transmits the movie image data after the completion of the transmission by the first transmission unit.

This application is a U.S. National Phase of PCT/JP2008/001787, filed Jul. 4, 2008, which claims priority to Japanese Patent Application No. 2007-197028, filed Jul. 30, 2007. The contents of all of the aforementioned applications are hereby incorporated by reference in their entirety.

### BACKGROUND OF THE INVENTION

The present invention relates to a drive recorder that records movie image data of a portion inside or outside of a vehicle in a traveling state in order to record evidence data for determining a cause of an accident, a drive recorder system, a method of controlling a drive recorder, and a program.

Heretofore, as such drive recorders, a drive recorder that stores movie image data in a nonvolatile memory such as an MRAM and turns on a save flag in accordance with a data save request due to detection of occurrence of an accident so as to prevent the movie image data from being erased when the accident occurs, has been known (e.g., see Japanese Unexamined Patent Application Publication No. 2003-69936).

### BRIEF SUMMARY OF THE INVENTION

In a case where a vehicle is burned in a large scale accident, an MRAM in such a drive recorder as described in the above patent document also gets burned so that a problem may arise in that the movie image data vanishes. Namely, even when the movie image data is recorded as evidence data for determining a cause of an accident in the event of the accident, the evidence data may vanish due to the accident, which is like putting “the cart before the horse”.

In view of the above problem, a purpose of the embodiments of the invention is that it provides a drive recorder capable of reducing the risk of losing evidence data in the event of an accident, a drive recorder system, a method for controlling a drive recorder and a program.

A drive recorder in accordance with embodiments of the present invention includes an image capture unit that captures an image of at least a front view of a vehicle in a traveling state, a movie image data generation unit that generates movie image data from a video signal captured by the image capture unit, a storage section that stores at least the movie image data, a record unit that records at least the movie image data into the storage section, an event occurrence detection unit that detects the occurrence of a predetermined event, a still image data generation unit that generates still image data including a plurality of still images at predetermined intervals from the video signal or the movie image data, a first transmission unit that transmits the still image data generated by the still image data generation unit to an external device via a wireless network when the event occurrence detection unit detects the occurrence of a predetermined event, and a second transmission unit that transmits the movie image data stored in the storage section after the completion of the transmission by the first transmission unit.

In another aspect, the present invention provides a method of controlling a drive recorder to be used by being installed in a vehicle, the method including the following steps executed by the drive recorder. The method includes an image capturing step of capturing an image of at least a front view of the vehicle in a traveling state, a recording step of generating movie image data from a captured video signal and recording the movie image data into a storage section, an event occurrence detecting step of detecting the occurrence of a predetermined event, a still image data generating step of generating still image data including a plurality of still images at predetermined intervals from the video signal or the movie image data, and a transmission step of transmitting the movie image data and the still image data to an external device via a wireless network when the event occurrence detection unit detects the occurrence of a predetermined event. The movie image data is transmitted after the completion of the transmission of the still image data in the transmission step.

With the above configuration, the still image data can be generated from the captured video signal or the generated movie image data. When a predetermined event occurs (e.g., an accident occurs), the still image data is transmitted to the external device at the highest priority. As a result, it is possible to reduce the risk of losing evidence data. Namely, since the amount of still image data is smaller and the still image data can be transmitted in a short time period as compared to the movie image data, the possibility is high that the transmission is finished before the drive recorder is burned, even if the vehicle is burned. Consequently, since at least the still image data can be stored in the external device, it is possible to reduce the risk of losing the evidence data due to an accident to as little as possible. In addition, since the movie image data is also transmitted after the transmission of the still image data is completed, the effectiveness of the evidence data is not degraded. Namely, it is possible to steadily and effectively preserve the evidence.

The drive recorder described above can further include a save unit that saves at least the still image data generated by the still image data generation unit in a detachable memory device when the event occurrence detection unit detects the occurrence of a predetermined event.

With the above configuration, since not only the still image data but also the movie image data are saved in a detachable memory device, it is possible to more surely preserve the evidence.

In the drive recorder described above, the save unit can save the movie image data stored in the storage section to the memory device after saving the still image data to the memory device.

With the above configuration, since not only the still image data but also the movie image data are saved in the detachable memory device, it is possible to perform a more useful preservation of evidence.

In the drive recorder described above, the record unit can convert the video signals divided for each predetermined time period into two or more movie image data files and can record the movie image data files into the storage section.

With the above configuration, since the movie image data files are generated by dividing the video signal for each predetermined time period, it is possible to save the movie image data by distributing them into the plurality of files, thereby enhancing the preservation property of the evidence data.

In the drive recorder described above, the second transmission unit can transmit the plurality of movie image data files to the external device in an order tracing back from occurrence of a predetermined event.

With the above configuration, the evidence data can be preserved depending on a degree of usefulness of the evidence data.

In the drive recorder described above, the second transmission unit can transmit the movie image data files in a time period after occurrence of a predetermined event to the external device, after the transmission of the movie image data files in a time period before occurrence of the predetermined event is completed.

With the above configuration, the movie image data obtained by capturing a state in a time period after occurrence of a predetermined event (e.g., video image data in a case where a counter vehicle has run away after occurrence of a small car accident) can be preserved as important evidence data.

In the drive recorder described above, at least one of the first transmission unit and the second transmission unit can transmit, to the external device, vehicle information including at least one of information about a clock time when capturing an image by the image capture unit, information about a position of the vehicle according to a GPS, information about a speed, information about an on-off state of a direction indicator, information about a brake pressure and information about a rudder angle of the steering wheel.

With the above configuration, the vehicle information that may be necessary for determining a cause of an accident can be saved as important evidence data.

In the drive recorder described above, the movie image data can include audio data.

With the above configuration, the audio data that may be necessary for determining a cause of an accident can be saved as a part of the movie image data.

A drive recorder system according to the embodiments of the invention includes the above described drive recorder and a network device that functions as an external device.

A program according to the embodiments of the invention is adapted to execute each of steps of the control method of the above described drive recorder.

By using these steps, it is possible to form the drive recorder system capable of reducing the risk of losing evidence data when an accident occurs.

### BRIEF DESCRIPTION OF THE DRAWINGS

FIG. 1 is a system configuration diagram showing a drive recorder system according to a first embodiment of the invention.

FIG. 2 is a block diagram showing a drive recorder.

FIG. 3 is a flowchart showing operations of the drive recorder.

FIG. 4 is an explanatory view showing a sequence of transmission/saving of traveling data.

FIG. 5 is an explanatory view showing a display example of still image data.

FIG. 6 is a flowchart showing operations of the drive recorder according to a second embodiment.

FIG. 7 is an explanatory view showing another example of the sequence of transmission/saving of the traveling data.

FIG. 8 is an explanatory view showing another example of the sequence of transmission/saving of the traveling data.

### DESCRIPTION OF REFERENCE NUMERALS AND SIGNS

10 - - - drive recorder, 11 - - - communication processing section, 14 - - - GPS receiver, 15 - - - RTC, 16 - - - acceleration sensor, 17 - - - storage section, 18 - - - video/audio signal processing section, 19 - - - central controller, 22 - - - detachable memory device, 23 - - - camera module, 24 - - - microphone, 30 - - - personal computer, 40 - - - network device, 41 - - - network storage, G - - - still image data, M - - - movie image data file

### DETAILED DESCRIPTION OF THE INVENTION

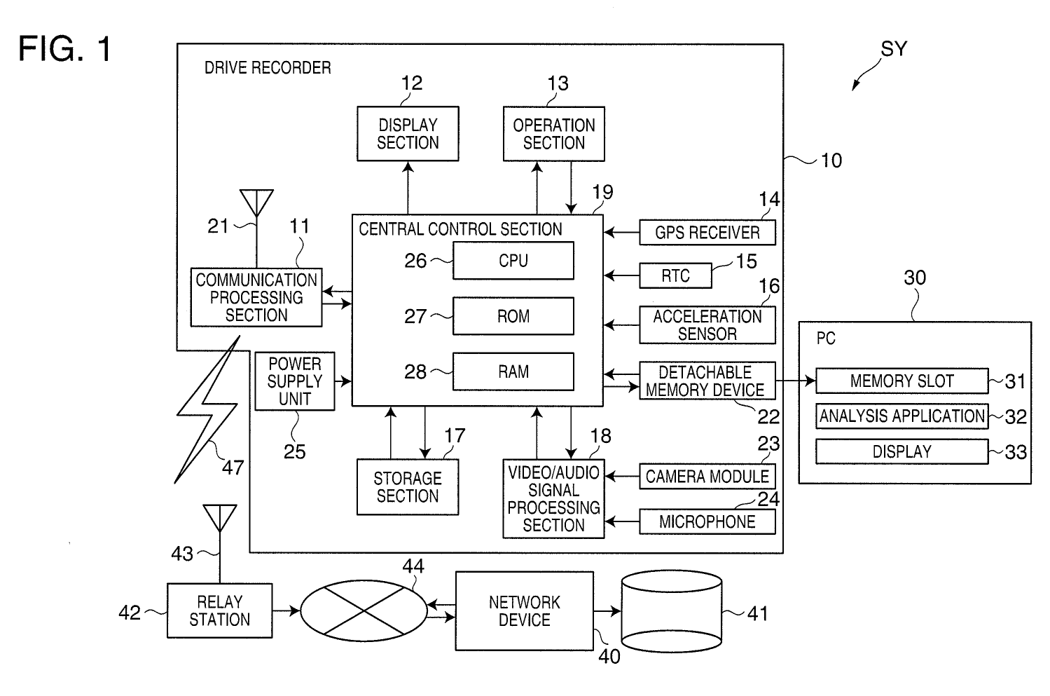

A drive recorder, a drive recorder system, a method for controlling the drive recorder and a program according to embodiments of the invention will be described with reference to the accompanying drawings. FIG. 1 is a system configuration diagram of a drive recorder system SY. As shown in FIG. 1, the drive recorder system SY includes a drive recorder 10 to be installed in a vehicle (an automobile) (not shown), a personal computer 30 (hereinafter, referred to as PC) for allowing a user as an owner of the drive recorder 10 to browse or listen to various kinds of data recorded in the drive recorder 10, and a network device 40 (an external device) for receiving and storing various kinds of data that is transmitted from the drive recorder 10.

The drive recorder 10 has a communication processing section 11, a display section 12, an operation section 13, a GPS (Global Positioning System) receiver 14, an RTC (Real Time Clock) 15, an acceleration sensor 16, a storage section 17, a video/audio signal processing section 18, a central control section 19, a detachable memory device 22, a camera module 23, a microphone 24 and a power supply unit 25.

The communication processing section 11 has an antenna 21 for transmitting or receiving a radio signal and communicates with the network device 40 via a wireless communication network 47. The display section 12 includes a display and an indicator (LED) (not shown) and displays a state of an operation of the drive recorder 10 such as a communication operation with the network device 40 and a writing operation to the detachable memory device 22. The operation section 13 has switches (not shown) for forcedly executing an ON-OFF operation of a power source switch, a detaching operation of the detachable memory device 22, a communicating operation with the network device 40 and a writing operation of the detachable device 22.

The GPS receiver 14 is adapted to receive a radio signal including data of orbits of a plurality of satellites and a clock time from an atomic clock built in the satellite. The central control section 19 computes relative distance differences with respect to the satellites in accordance with time differences of the received radio signals and determines a present position on the basis of the computed results. The RTC (Real Time Clock) 15 is a timer dedicated chip and the central control section 19 realizes a calendar function and a timing function by using the RTC 15. The acceleration sensor 16 is adapted to detect a traveling direction and an accelerated velocity (a speed) of a vehicle. The central control section 19 can detect the occurrence of an accident (e.g., the occurrence of a predetermined event) by detecting an impact level by the acceleration sensor 16.

The camera module 23 is adapted to acquire a video signal that is a source of movie image data and still image data (hereinafter, a combination of both data is referred to as traveling data). The microphone 24 is adapted to acquire an audio signal that is a source of audio data included in the movie image data. The video/audio signal processing section 18 is adapted to process the video signal acquired from the camera module 23 and the audio signal acquired from the microphone 24 and includes an analogue signal processing section, an A/D conversion section, an image processing section, a compression processing section and the like. The power supply unit 25 has a rechargeable battery (not shown) that is connected to a battery of the vehicle and is charged by receiving power from the battery. As a result, the recording of the traveling data can be continued even under a condition that the power is not supplied from the vehicle due to occurrence of an accident.

The storage section 17 is adapted to store the traveling data and information additional to the data (e.g., vehicle information). The movie image data and the still image data are respectively and periodically stored thereto. Namely, when an accumulation amount of each data reaches a predetermined amount, the latest data is written by erasing the oldest data. The detachable memory device 22 includes a recording medium such as a memory card or the like. A memory slot (not shown) is provided in the drive recorder 10 so as to enable the detachable memory device 22 to be detachable. The traveling data before or after occurrence of an accident is written into the detachable memory device 22 in accordance with a command from the central control section 19.

The central control section 19 has a CPU 26, a ROM 27 and a RAM 28, and controls the entirety of the drive recorder 10. The ROM 27 stores a control program and control data for allowing the CPU 26 to execute various kinds of processes. In addition, the RAM 28 is used as a work area when the CPU 26 executes the various kinds of processes. The CPU 26 controls the above described structural components and transmits the traveling data output from the video/audio signal processing section 18 to the network device 40 and saves the vehicle data to the detachable memory device 22. In addition, the CPU 26 adds various information acquired from the GPS receiver 14, the RTC 15 and the acceleration sensor 16 to the traveling data as the vehicle information. The vehicle information added to the traveling data is information obtained when the traveling data is obtained by image-capturing.

On the other hand, the PC 30 has a memory slot 31, an analysis application 32, a display 33 and a hardware structure which may be installed in a general personal computer. The memory slot 31 is adapted to read the detachable memory device 22. The analysis application 32 is provided as an accessory of the drive recorder 10. The analysis application 32 reads the traveling data and the vehicle information saved in the detachable memory device 22 so as to perform various analysis processes and to display the read traveling data, the vehicle information and the analysis results on the display 33.

The network device 40 is coupled to the drive recorder 10 via the wireless network 47, a relay station 42 and a communication network 44, and is equipped with a network storage 41. The relay station 42 has an antenna 43 for communication of a radio signal with the antenna 21 of the drive recorder 10. Each of many relay stations is placed at a portion near a road so as not to discontinue the communication with a vehicle (drive recorder 10) traveling on the road. In addition, the network storage 41 is adapted to save the traveling data and the vehicle information at a time before and after an accident, the traveling data and the vehicle information being transmitted from the drive recorder 10. When the network device 40 receives the traveling data from the drive recorder 10, the network device first determines a clock time and a place of occurrence of an accident on the basis of the additional vehicle information. A manager of the network device 40 may confirm the above fact and may contact a police station or call an ambulance when it is assumed that an injured person exists.

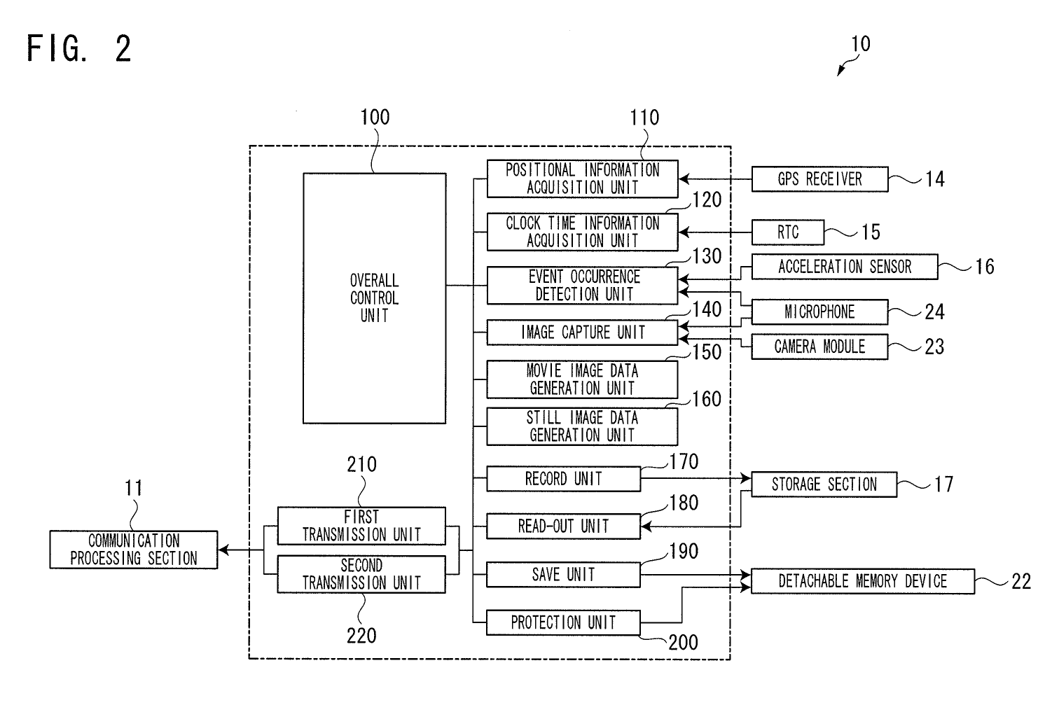

Next, a functional structure (a portion of a dashed line shown in the drawing) of the drive recorder 10 will be described with reference to FIG. 2. The drive recorder 10 includes, as the functional structure, an overall control unit 100, a positional information acquisition unit 110, a clock time information acquisition unit 120, an event occurrence detection unit 130, an image capture unit 140, a movie image data generation unit 150, a still image data generation unit 160, a record unit 170, a read-out unit 180, a save unit 190, a protection unit 200, a first transmission unit 210, and a second transmission unit 220.

The overall control unit 100 is coupled to each of the above units and in an overall manner, controls the above-mentioned units. The positional information acquisition unit 110 acquires information about a position obtained by the GPS receiver 14. The clock time information acquisition unit 120 acquires information about a clock time obtained by the RTC 15. The event occurrence detection unit 130 detects the occurrence of an accident on the basis of an impact level detected by the acceleration sensor 16 and an impulse force sound obtained from the microphone 24. In the embodiment, processes for transmitting and saving of the traveling data are executed upon the detection of occurrence of an accident as a trigger. The image capture unit 140 acquires the video signal and the audio signal obtained from the camera module 23 oriented to a front view of the vehicle and the microphone 24 so as to capture the front view of the vehicle in the traveling state.

The movie image data generation unit 150 generates movie image data on the basis of the video signal and the audio signal captured by the image capture unit 140. To be specific, the movie image data generation unit 150 generates a plurality of movie image data files on the basis of the video signals and the audio signals divided at predetermined time periods. The still image data generation unit 160 generates still image data formed of a plurality of still images at predetermined intervals on the basis of the video signal captured by the image capture unit 140. It is needless to say that still image data can be formed such that a plurality of still images are extracted from the movie image data file generated by the movie image data generation unit 150.

The record unit 170 records the movie image data file and the still image data generated by the movie image data generation unit 150 and the still image data generation unit 160 into the storage section 17. The vehicle information obtained by the positional information acquisition unit 110, the clock time information acquisition unit 120 or the like, every time when capturing the image, is recorded by being correlated to the movie image data file and the still image data.

The read-out unit 180 reads the traveling data and the vehicle information from the storage section 17 when the event occurrence detection unit 130 detects occurrence of an accident. The save unit 190 saves the traveling data and the vehicle information at a time before and after the occurrence of the accident read from the storage section 17 by the read-out unit 180 to the detachable memory device 22. The protection unit 200 is adapted to prevent save data saved in the detachable memory device 22 from being erased. To be specific, the protection unit 190 indicates locking by a password.

The first transmission unit 210 transmits the still image data and the vehicle information read by the read-out unit 180 to the network device 40 via the communication processing section 11. In addition, the second transmission unit 220 transmits the movie image data file (including the audio data) and the vehicle information read by the read-out unit 180 to the network device 40 via the communication processing section 11. The second transmission unit 220 starts its transmission process after the transmission by the first transmission unit 210 is completed. Meanwhile, each of the first and second transmission units 210 and 220 performs the transmission by adding a device ID of the drive recorder 10 when transmitting the traveling data. With this configuration, the network device 40 can determine which vehicle is involved in the accident. Each of the first and second transmission units 210 and 220 transmits a plurality of pieces of traveling data (e.g., a plurality of pieces of still image data and a plurality of movie image data files) in an order tracing back from occurrence of the accident. Namely, evidence data that is seemed to be more important is transmitted at the highest priority. In addition, the second transmission unit 220 transmits the plurality of movie image data files in a time period after occurrence of the accident after it transmits the plurality of movie image data files in a time period before occurrence of the accident.

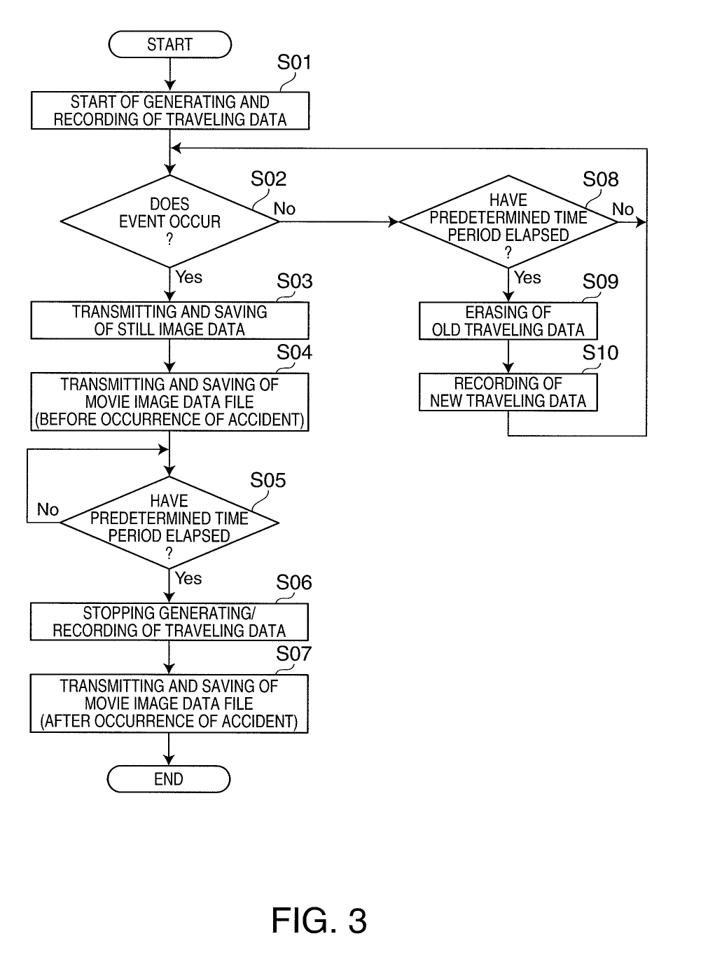

Next, operations of the drive recorder 10 will be described with reference to a flowchart shown in FIG. 3. The image capturing by using the camera module 23 and the microphone 24 is started in response to start of traveling of the vehicle (power-on caused by insertion of a vehicle key) or an operation of the operation section 13, and generating of the traveling data and recording of the traveling data are started in response to the image capturing (S01). Here, the occurrence of a predetermined event (e.g., an accident) is detected (S02: Yes), the plurality of pieces of still image data stored in the storage section 17 is first read so as to be transmitted to the network device 40 and saved in the detachable memory device 22 (S03).

After finishing the transmission and the saving of the still image data, the movie image data stored in the storage section 17 is read to be transmitted to the network device 40 and saved to the detachable memory device 22 (S04). Note that, each data transmitted and saved in the processes S03 and S04 is data at a time before occurrence of the accident and the data is transmitted and saved in an order tracing back from the occurrence of the accident. In addition, the transmitting process and the storing process are concurrently performed. While the processes S03 and S04 are performed, processes of generating the traveling data and recording the traveling data are continued.

Next, it is determined whether or not a predetermined time period has passed from the occurrence of the accident (S02: a time point of judgment of Yes) on the basis of a timing result of the RTC 15 (S05). The predetermined time period is preferably a time period (e.g., 15 seconds to 30 seconds) whereby recording after occurrence of the accident can be performed sufficiently. When the predetermined time period has elapsed (S05: Yes), the processes of generating and recording the traveling data are stopped (S06), and then the movie image data files recorded in the storage section 17 after occurrence of the accident is read to be transmitted to the network device 40 and saved in the detachable memory device 22 (S07). Regarding the movie image data files in a time period after occurrence of the accident, the movie image data files are transmitted and saved in a time-series manner (e.g., from an old one). Meanwhile, it is possible to perform the generating and the recording of only the movie image data files by omitting the generating and recording of the still image data after the occurrence of the accident (S02: after judgment of Yes).

On the other hand, in a case where a predetermined event does not occur even when a predetermined time period has elapsed from the starting of recording of the traveling data (S02: No, S08: Yes), old traveling data (the still image data and the movie image data files) in the storage section 17 is erased (S09) and new traveling data is recorded (S10). Namely, in the processes S08 to S10, unless occurrence of an accident is detected, the recording of the traveling data is performed in a loop manner. Note that, “the predetermined time period” as a determination criterion in the process S08 can be the same as “the predetermined time period” as a determination criterion in the process S05 or can be different from that.

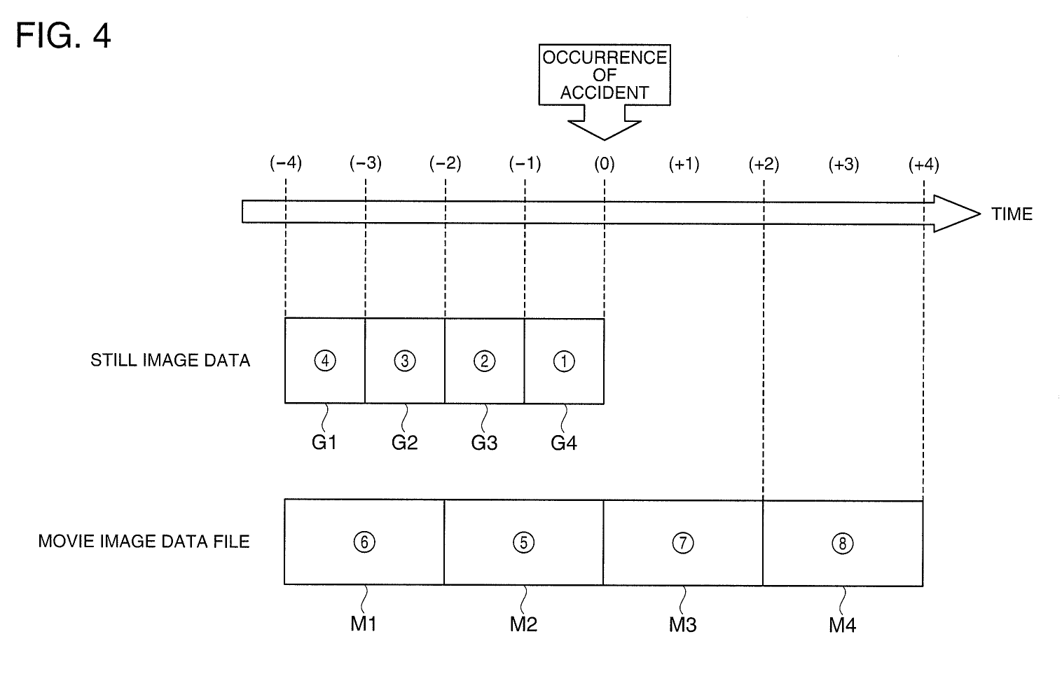

Next, a sequence of transmitting or saving of the traveling data will be described with reference to FIG. 4. The drawing indicates that the time advances to the right. Here, a time point (0) means a time when the accident occurs. When a numerical value is negative, each numerical value between parentheses designates each time point before occurrence of the accident. The greater the value (absolute value) is, the longer the time point is back to the past from the time point of occurrence of the accident. When a numerical value is positive, each numerical value between parentheses designates each time point after occurrence of the accident. The greater the value is, the longer the time point is advanced from the time point of occurrence of the accident.

In the embodiment as shown in the drawing, the still image data at a time before the occurrence of the accident and the movie image data files in a time period before and after occurrence of the accident are transmitted and saved. The sequences of the transmitting and the saving are the same. For example, regarding the still image data, a still image data G1 is recorded in a time period from (−4) to (−3), a still image data G2 is recorded in a time period from (−3) to (−2), a still image data G3 is recorded in a time period from (−2) to (−1), and a still image data G4 is recorded in a time period from (−1) to (0). In the above case, the transmitting and the saving are performed in the sequence of G4, G3, G2 to G1 as shown by circled numerals of 1 to 4.

On the other hand, regarding the movie image data files, a movie image data file M1 is recorded in a time period from (−4) to (−2), a movie image data file M2 is recorded in a time period from (−2) to (0), a movie image data file M3 is recorded in a time period from (0) to (+2), and a movie image data file M4 is recorded in a time period from (+2) to (+4). In the above case, the transmitting and the saving are performed in a sequence of M2, M1, M3 to M4 as shown by circled numerals of 5 to 8. However, since the movie image data files M3 and M4 are data in a time period after occurrence of the accident, the files are transmitted after being delayed by a predetermined time period from occurrence of the accident (S05 to S07, in FIG. 3).

Thus, since the still image data is transmitted prior to the movie image data file, it is possible to confidently preserve evidence data even when the vehicle is involved in a large accident that could burn the vehicle. That is because a data amount of the still image data is smaller than that of the movie image data file so that a time period necessary for reading, transmitting or saving the still image data is short. In addition, since each of the still image data and the movie image data is transmitted in a plurality of units by being divided by a predetermined time period, the data can be distributed so that a risk of losing evidence data can be reduced. Further, regarding the traveling data before the occurrence of the accident, since the data is transmitted in an order tracing back from occurrence of the accident, the data is saved in a sequence from data which is seemed to be important for determining a cause of the accident, that is, the data is saved more efficiently. Further, in addition, in a case where a degree of the accident is not so large and there is enough time for transmitting or saving the data, the movie image data file in a time period after the occurrence of the accident is also transmitted and saved so that a value as the evidence data is not degraded.

In FIG. 4, a case where a predetermined time interval for dividing the movie image data file is longer than a predetermined time interval for dividing the still image data is exemplarily shown. However, the length of the interval is arbitrary and it is possible to make the predetermined time interval for dividing the movie image data file to be shorter than the predetermined time interval for dividing the still image data. In addition, while the case that each of the still image data and the movie image data file is divided by the equal intervals is exemplarily shown, it is possible to make the intervals to be wider as the transmission order, that is, unequal intervals.

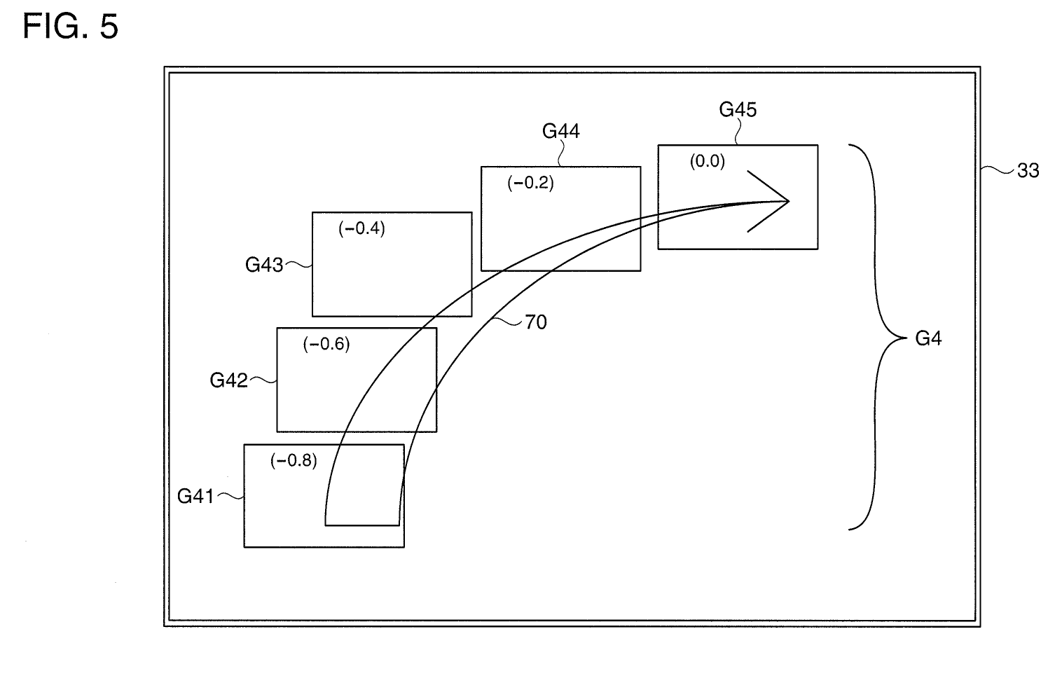

Next, displaying in a case where the still image data saved in the detachable memory device 22 or the network storage 41 is fetched into the PC 30, will be described with reference to FIG. 5. Meanwhile, a displaying algorithm for displaying the still image data on the display 33 is based on the analysis application 32 installed in the PC 30 (see FIG. 1).

Here, an example of displaying the still image data G4 (e.g., still image data recorded in a time period from (−1) to (0)) shown in FIG. 5 is described. As described above, the still image data includes a plurality of still images. In a case where the still image data G4 includes five still images including a still image G41 captured in a time period from (−1.0) to (−0.8), a still image G42 captured in a time period from (−0.8) to (−0.6), a still image G43 captured in a time period from (−0.6) to (−0.4), a still image G44 captured in a time period from (−0.4) to (−0.2) and a still image G45 captured in a time period from (−0.2) to (0.0) as shown in the drawing, the five images are displayed in a time-series manner. Regarding the arrangement of the images, the images are arranged on an arrow 70 converging along with reduction of an acceleration degree on the basis of the information about a speed (e.g., the detection result of the acceleration sensor 16) and the information about a clock time (e.g., the timing result of the RTC 15) included in the vehicle information that is added to the still image data G4 (e.g., the width of the arrow indicates the speed at a time of recording each still image). The arrow 70 also indicates change in a position of the vehicle on the basis of the positional information (e.g., the received data of the GPS receiver 14) included in the vehicle information. Namely, in a case shown in FIG. 5, the shape of the arrow 70 indicates that the vehicle is greatly curved to the right.

Thus, since the captured result (e.g., the still images) can be confirmed together with the change in the speed or position of the vehicle at the occurrence of the accident, it is possible to objectively grasp the situation of the accident and to use the captured result in order to determine the cause of the accident. Here, it is preferable that the display is constituted so as to be visually confirmed by the network device 40.

As described above, in accordance with the embodiment, the still image data is generated from the captured video signal. When the occurrence of the accident is detected, the still image that has a data amount smaller than that of the movie image data and can be transmitted in a short time as compared to the movie image data, is transmitted to the network device 40 prior to the movie image data. As a result, at least the still image data can be saved in the network storage 41 so that a risk of losing the evidence data due to the accident can be reduced to a minimum level. In addition, since the movie image data file is also transmitted after completion of transmission of the still image data, it is possible to achieve the preservation of evidence having certainty and usefulness without degrading the usefulness of the evidence data.

Further, since the still image data and the movie image data file are not only transmitted to the network device 40, but also saved in the detachable memory device 22, it is possible to preserve the evidence even if an error occurs during the processing of transmission.

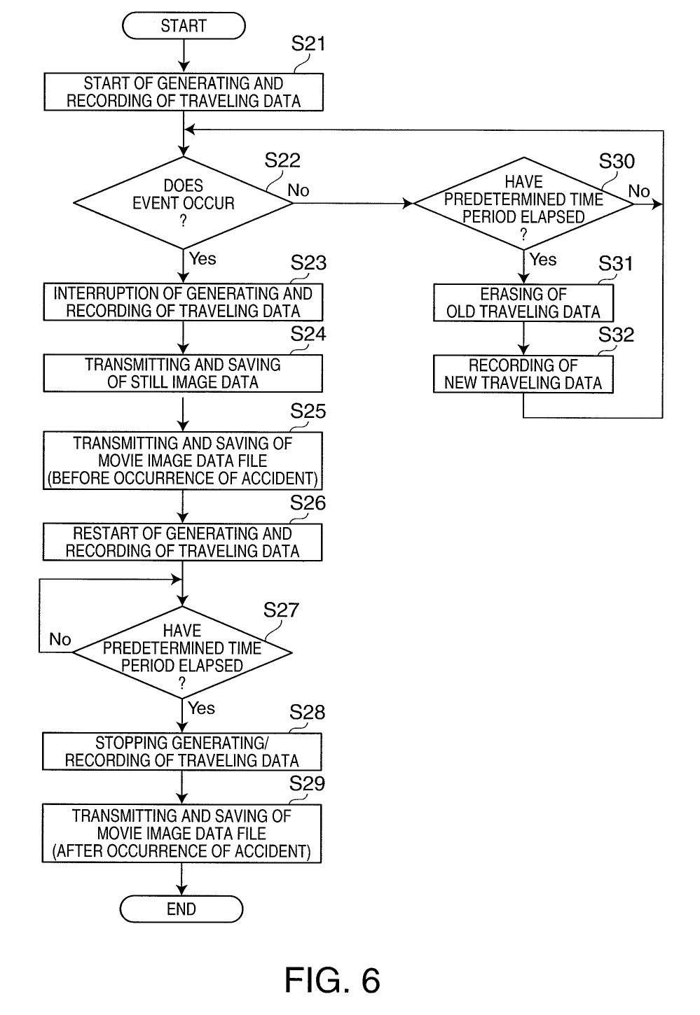

Next, a second embodiment of the invention will be described with reference to FIG. 6. In the above embodiment, the still image data and the movie image data file are formed to be recorded in the storage section 17 at a normal state. However, in the present embodiment, only the movie image data file is generated and is recorded in the storage section 17 at the normal state and the still image data is generated when an accident occurs, which is different from the above embodiment. The embodiment is described by mainly focusing on aspects different from the first embodiment (the flowchart in FIG. 3).

Generating and recording of traveling data (e.g., indicating a movie image data file in the embodiment) are started (S21). When the occurrence of an accident is detected (S22: Yes), the generating and the recording of the traveling data are temporarily stopped (S23). Under a condition that the generating and the recording of the traveling data are interrupted, still image data is generated from the movie image data file recorded in the storage section 17, and a transmission process and a save process are performed (S24). After the transmission process and the save process of the still image data are finished, a transmission process and a save process of the movie image data file (e.g., before occurrence of the accident) are performed (S25).

When the transmission process and the save process of the movie image data are finished, the operations of generating and recording the traveling data are restarted (S26). It is determined whether or not a predetermined time period has elapsed from the restart (S27). When the predetermined time period has elapsed (S27: Yes), the operations of generating and recording the traveling data are stopped (S28) and the movie image data file at a time after occurrence of the accident is transmitted and saved (S29). Regarding processes (S30 to S32) in a case where the occurrence of an accident is not detected, only a point that the still image data is not erased nor recorded as the traveling data is different from that of the first embodiment and other points are the same as the first embodiment (S08 to S10 in FIG. 3) so that the description is omitted.

As described above, since it is not necessary to generate the still image data at a normal state in accordance with the second embodiment, a control load can be reduced and a capacity of the storage section 17 for storing the still image data is not needed. In addition, since it is necessary to generate the still image data, a control load is increased when an accident occurs. However, increase of the control load can be suppressed by temporarily stopping the generating and recording of the traveling data, and thereby, it is possible to immediately perform the transmission process and the save process of the data.

Meanwhile, in the above two embodiments, the still image data recorded before the occurrence of the accident is made to be an object to be transmitted or saved. However, it is possible to transmit or save the still image data recorded after occurrence of the accident. In addition, in the above two embodiments, after all the still image data at a time before occurrence of the accident is transmitted, the movie image data files in the time period before occurrence of the accident are transmitted and saved. However, after the completion of the transmission of the still image data in a predetermined time period before occurrence of the accident, the movie image data files in a predetermined time period before occurrence of the accident can be transmitted, and then the still image data and the movie image data file at a time before the above predetermined time period can be transmitted.

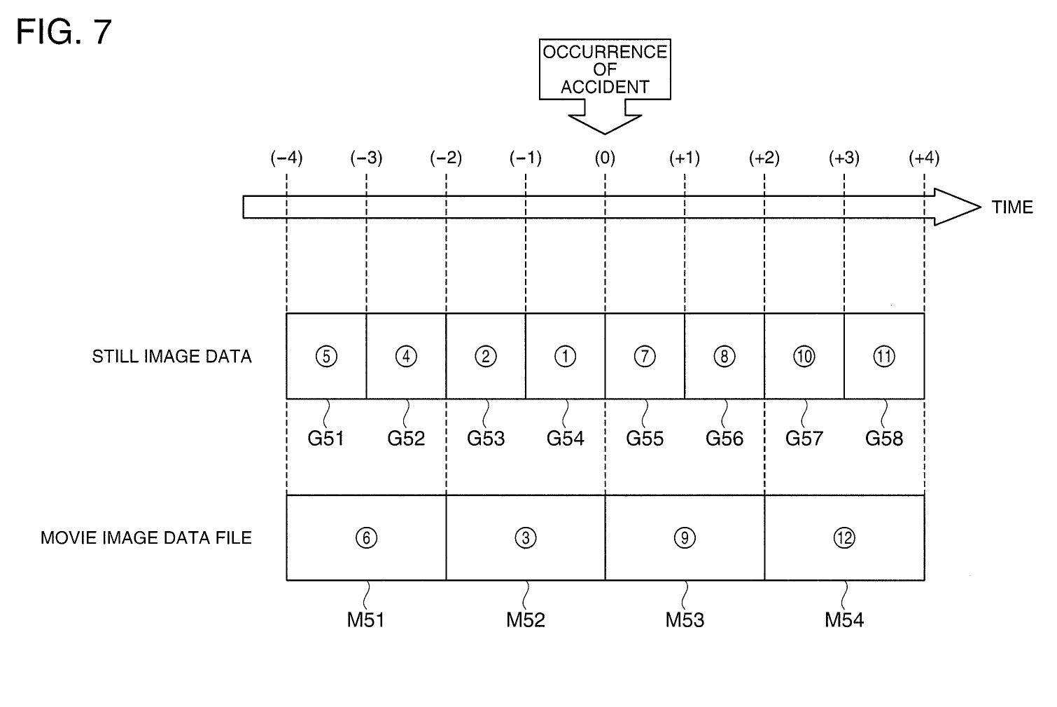

Namely, in a case of an example shown in FIG. 7, traveling data before the occurrence of the accident can be transmitted in a sequence of still image data G54 recorded in a time period from (−1) to (0), still image data G53 recorded in a time period from (−2) to (−1), a movie image data file M52 recorded in a time period from (−2) to (0), still image data G52 recorded in a time period from (−3) to (−2), still image data G51 recorded in a time period from (−4) to (−3), and a movie image data file M51 recorded in a time period from (−4) to (−2) (e.g., see circled numerals of 1 to 6). Traveling data after the occurrence of the accident can be transmitted and staved in a sequence of still image data G55 recorded in a time period from (0) to (+1), still image data G56 recorded in a time period from (+1) to (+2), a movie image data file M53 recorded in a time period from (0) to (+2), still image data G57 recorded in a time period from (+2) to (+3), still image data G58 recorded in a time period from (+3) to (+4), and a movie image data file M54 recorded in a time period from (+2) to (+4) (e.g., see circled numerals of 7 to 12).

In addition, in the two embodiments, while the camera module 23 and the microphone 24 are provided to be directed to a front view of the vehicle, another camera module 23 and another microphone 24 can be provided at the rear portion of the vehicle. It is preferable to prioritize the front view of the vehicle rather than the rear view thereof regarding the transmission sequence.

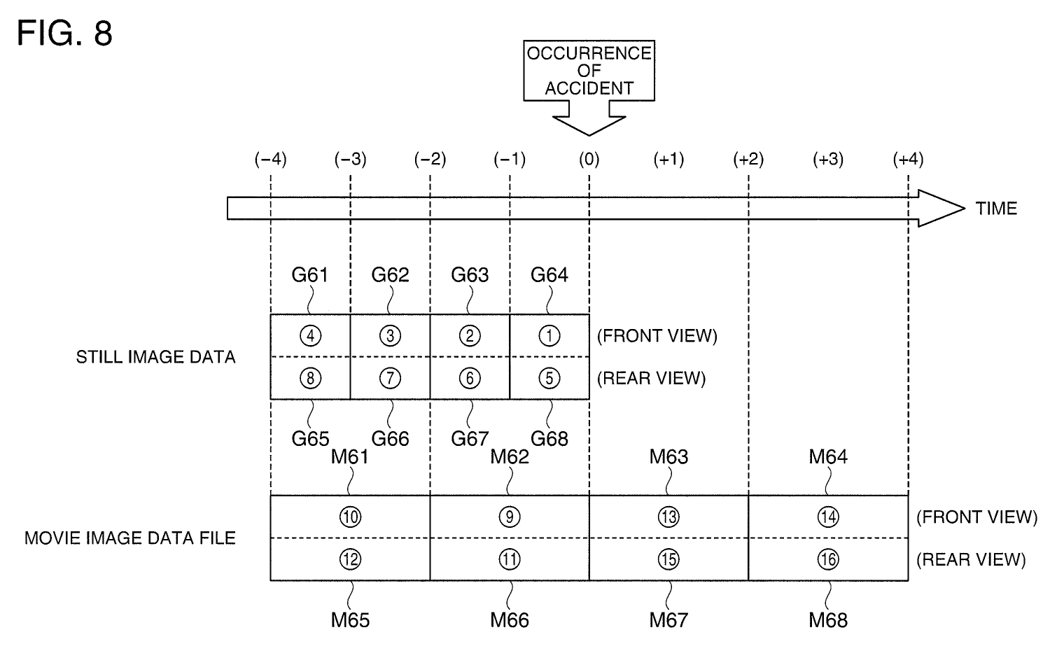

Namely, as shown in FIG. 8, the traveling data before the occurrence of the accident is preferably transmitted and saved in a sequence of still image data G64 of the front view of the vehicle recorded in a time period from (−1) to (0), still image data G63 of the front view of the vehicle recorded in a time period from (−2) to (−1), still image data G62 of the front view of the vehicle recorded in a time period from (−3) to (−2), still image data G61 of the front view of the vehicle recorded in a time period from (−3) to (−2), still image data G68 of the rear view of the vehicle recorded in a time period from (−1) to (0), still image data G67 of the rear view of the vehicle recorded in a time period from (−2) to (−1), still image data G66 of the rear view of the vehicle recorded in a time period from (−3) to (−2), still image data G65 of the rear view of the vehicle recorded in a time period from (−4) to (−3), a movie image data file M62 of the front view of the vehicle recorded in a time period from (−2) to (0), a movie image data file M61 of the front view of the vehicle recorded in a time period from (−4) to (−2), a movie image data file M66 of the rear view of the vehicle recorded in a time period from (−2) to (0), and a movie image data file M65 of the rear view of the vehicle recorded in a time period from (−4) to (−2) (e.g., see circled numerals of 1 to 12). In addition, traveling data after the occurrence of the accident is preferably transmitted and saved in a sequence of a movie image data file M63 of the front view of the vehicle recorded in a time period from (0) to (+2), a movie image data file M64 of the front view of the vehicle recorded in a time period from (+2) to (+4), a movie image data file M67 of the rear view of the vehicle recorded in a time period from (0) to (+2), a movie image data file M68 of the rear view of the vehicle recorded in a time period from (+2) to (+4) (e.g., see circled numerals of 13 to 16).

Regarding the capturing of images, not only an image of the front view or rear view of the vehicle, but also an image of a right or left scene or a diagonally right or left scene can be captured. In addition, not only an image of the outside of the vehicle, but also an image of the inside of the vehicle can be captured.

While the vehicle information to be transmitted and saved together with the traveling data includes the information about a position obtained from the GPS receiver 14, the information about a clock time obtained from the RTC, and the information about a speed obtained from the acceleration sensor 16, the vehicle information can additionally include information about an on-off state of a direction indicator mounted on the vehicle, information about a brake pressure, information about a rudder angle of a steering wheel and the like.

While occurrence of a predetermined event (e.g., an accident) is detected on the basis of the information obtained from the acceleration sensor 16 and the microphone 24 in the above two embodiments, it is possible to detect occurrence of an accident by sensing an impact to a bonnet hood of a vehicle or sensing an action of an air-bag. Regarding the predetermined event, not only the occurrence of an accident, but also movement of a vehicle due to a storm or occurrence of theft can be detected.

In addition, a mobile phone (not shown) can be used as the communication processing section 11 for performing radio communication with the network device 40. In the above case, when the mobile phone is configured such that the mobile phone can function as the communication processing section 11 only in a drive mode, an operation for a telephone call or an electric mail during the driving can be prohibited, which may be preferable for safety of a user.

Each of the structural components of the drive recorder 10 or the PC 30 described in the two embodiments can be provided by a computer program. In addition, the programs can be provided by being stored to various kinds of recording media (e.g., a CD-ROM, a flash memory and the like). Namely, the program for causing a computer to function as each unit of the drive recorder 10 or the PC 30 and the recording medium containing the program recorded therein are included within the scope or sprit of the invention. In addition, the embodiments can be modified without departing from the scope or sprit of the invention.

1. A drive recorder, comprising:
an image capture unit that captures an image of at least a front view of a vehicle in a traveling state;
a movie image data generation unit that generates movie image data from a video signal captured by the image capture unit;
a storage section that stores at least the movie image data;
a record unit that records at least the movie image data into the storage section;
an event occurrence detection unit that detects an occurrence of a predetermined event;
a still image data generation unit that generates still image data including a plurality of still images at predetermined intervals from the video signal or the movie image data;
a first transmission unit that transmits the still image data generated by the still image data generation unit to an external device via a wireless network when the event occurrence detection unit detects the occurrence of a predetermined event; and
a second transmission unit that transmits the movie image data stored in the storage section after completion of the transmission by the first transmission unit.

2. The drive recorder according to claim 1, further comprising:
a save unit that saves at least the still image data generated by the still image data generation unit into a detachable memory device when the event occurrence detection unit detects the occurrence of a predetermined event.

3. The drive recorder according to claim 2, wherein
the save unit saves the movie image data stored in the storage section into the memory device after saving the still image data.

4. The drive recorder according to claim 1, wherein
the record unit converts the video signals divided for each predetermined time period into two or more movie image data files and records the movie image data files into the storage section.

5. The drive recorder according to claim 4, wherein
the second transmission unit transmits the plurality of movie image data files to the external device in an order tracing back from occurrence of a predetermined event.

6. The drive recorder according to claim 5, wherein
the second transmission unit transmits the movie image data file obtained after the occurrence of a predetermined event, after completion of the transmission of the movie image data file obtained before occurrence of a predetermined event.

7. The drive recorder according to claim 1, wherein
at least one of the first transmission unit and the second transmission unit transmits vehicle information including at least one of information about a clock time when capturing an image by the image capture unit, information about a position of the vehicle by using a GPS device, information about a speed, information about an on/off state of a direction indicator, information about a brake pressure, and information about a rudder angle of a steering wheel, to the external device.

8. The drive recorder according to claim 1, wherein
the movie image data includes audio data.

9. A drive recorder system, comprising:
the drive recorder according to claim 1; and
a network device that functions as the external device.

10. A method of controlling a drive recorder to be used by being installed in a vehicle including steps executed by the drive recorder, the method comprising:
capturing an image of at least a front view of the vehicle in a traveling state;
generating movie image data from a captured video signal and recording the movie image data to a storage section;
detecting an occurrence of a predetermined event;
generating still image data including a plurality of still images at predetermined intervals from the video signal or the movie image data; and
transmitting the movie image data and the still image data to an external device via a wireless network when an event occurrence detection unit detects the occurrence of a predetermined event, wherein
the movie image data is transmitted after completion of the transmission of the still image data.

11. A program that causes a computer to execute the control method of controlling a drive recorder according to claim 10.
